(19) United States
(12) Patent Application Publication
(10) Pub. No.: US 2013/0055058 A1
(43) Pub. Date: Feb. 28, 2013

(54) Animation for Recalculating Formulas, Sparklines and Conditional Formatting in an Electronic Document

(71) Applicants: Josh Leong, Seattle, WA (US); Andrew J. Becker, Duvall, WA (US); Chad B. Rothschiller, Edmonds, WA (US); Karen Xiaoxu Cheng, Seattle, WA (US); B. Scott Ruble, Bellevue, WA (US); Kevin H. Fan, Bellevue, WA (US); Su-Piao B. Wu, Sammamish, WA (US); Amit A. Velingkar, Redmond, WA (US)

(72) Inventors: Josh Leong, Seattle, WA (US); Andrew J. Becker, Duvall, WA (US); Chad B. Rothschiller, Edmonds, WA (US); Karen Xiaoxu Cheng, Seattle, WA (US); B. Scott Ruble, Bellevue, WA (US); Kevin H. Fan, Bellevue, WA (US); Su-Piao B. Wu, Sammamish, WA (US); Amit A. Velingkar, Redmond, WA (US)

(73) Assignee: Microsoft Corporation, Redmond, WA (US)

(21) Appl. No.: 13/220,225

(22) Filed: Aug. 29, 2011

(51) Int. Cl. G06F 17/00

(52) U.S. Cl. 715/219

(57) ABSTRACT

Animation for the recalculation of formulas in a spreadsheet may be provided. A user interface may be displayed on a computer for updating formula output values. The computer may then receive an update of formula input values in a formula utilized for generating the formula output values. The computer may then animate a display the formula output values being replaced with recalculated formula output values based on the received update. Animation for sparklines and conditionally formatted content in a spreadsheet may also be provided. A user interface may be provided for displaying sparklines and conditionally formatted content in the spreadsheet. The computer may then receive an update of one or more values associated with the sparklines and the conditionally formatted content. The computer may then animate a change in the display of the sparklines and the conditionally formatted content based on the received update.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Computer application programs include functionality for utilizing formulas to perform calculations in a spreadsheet and further provide functionality for presenting the calculation results as numerical data and also in the form of charts or graphs. When input data utilized in the formulas is changed or updated, the calculation results (i.e., the formula output data) are also updated instantaneously. Drawbacks associated with the aforementioned instantaneous updates include a lack of a cause-and-effect understanding as to how altering a formula input causes the formula output to change, users not knowing when the outputs of formulas have updated due to values changing instantly (thus making it easy for users to miss) and users not being provided a sense of how the presentation of data has changed from an old state to a new state with respect to sparklines and conditional formatting (e.g., whether the data has increased or decreased or how a trend has changed). It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for animating the recalculation of formulas in a spreadsheet may be provided. A user interface may be displayed on a computer for updating formula output values. The computer may then receive an update of formula input values in a formula utilized for generating the formula output values. The computer may then animate a display the formula output values being replaced with recalculated formula output values based on the received update.

Additional embodiments are provided for animating sparklines and conditionally formatted content in a spreadsheet. A user interface may be provided for displaying sparklines and conditionally formatted content in the spreadsheet. The computer may then receive an update of one or more values associated with the sparklines and the conditionally formatted content. The computer may then animate a change in the display of the sparklines and the conditionally formatted content based on the received update.

These and other features and advantages will be apparent from a reading of the following detailed description and a review of the associated drawings. It is to be understood that both the foregoing general description and the following detailed description are illustrative only and are not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a computer screen display of a user interface showing a formula output prior to recalculation, in accordance with an embodiment;

FIG. 2 is a computer screen display of a user interface showing an intermediate stage of an animation of formula output values being recalculated, in accordance with an embodiment;

FIG. 3 is a computer screen display of a user interface showing a final stage of an animation of a formula output values being recalculated, in accordance with an embodiment;

FIG. 4 is a computer screen display of a user interface showing formula output values prior to recalculation, in accordance with an embodiment;

FIG. 5 is a computer screen display of a user interface showing an intermediate stage of an animation of formula output values being recalculated, in accordance with an embodiment;

FIG. 6 is a computer screen display of a user interface showing a final stage of an animation of formula output values being recalculated, in accordance with an embodiment;

FIG. 7 is a computer screen display of a user interface showing sparklines prior to being updated, in accordance with an embodiment;

FIG. 8 is a computer screen display of a user interface showing an intermediate stage of an animation of sparklines being updated, in accordance with an embodiment;

FIG. 9 is a computer screen display of a user interface showing a final stage of an animation of sparklines being updated, in accordance with an embodiment;

FIG. 10 is a computer screen display of a user interface showing conditional formatting data bars prior to being updated, in accordance with an embodiment;

FIG. 11 is a computer screen display of a user interface showing an intermediate stage of an animation of conditional formatting data bars being updated, in accordance with an embodiment;

FIG. 12 is a computer screen display of a user interface showing a final stage of an animation of conditional formatting data bars being updated, in accordance with an embodiment;

FIG. 13 is a flow diagram illustrating a routine for animating the recalculation of formulas in a spreadsheet, in accordance with an embodiment;

FIG. 14 is a flow diagram illustrating a routine for animating sparklines and conditionally formatted content in a spreadsheet, in accordance with an embodiment;

FIG. 15 is a simplified block diagram of a computing device with which various embodiments may be practiced;

FIG. 16A is a simplified block diagram of a mobile computing device with which various embodiments may be practiced;

FIG. 16B is a simplified block diagram of a mobile computing device with which various embodiments may be practiced; and

FIG. 17 is a simplified block diagram of a distributed computing system in which various embodiments may be practiced.

### DETAILED DESCRIPTION

Embodiments are provided for animating the recalculation of formulas in a spreadsheet may be provided. A user interface may be displayed on a computer for updating formula output values. The computer may then receive an update of formula input values in a formula utilized for generating the formula output values. The computer may then animate a display the formula output values being replaced with recalculated formula output values based on the received update.

Additional embodiments are provided for animating sparklines and conditionally formatted content in a spreadsheet. A user interface may be provided for displaying sparklines and conditionally formatted content in the spreadsheet. The computer may then receive an update of one or more values associated with the sparklines and the conditionally formatted content. The computer may then animate a change in the display of the sparklines and the conditionally formatted content based on the received update.

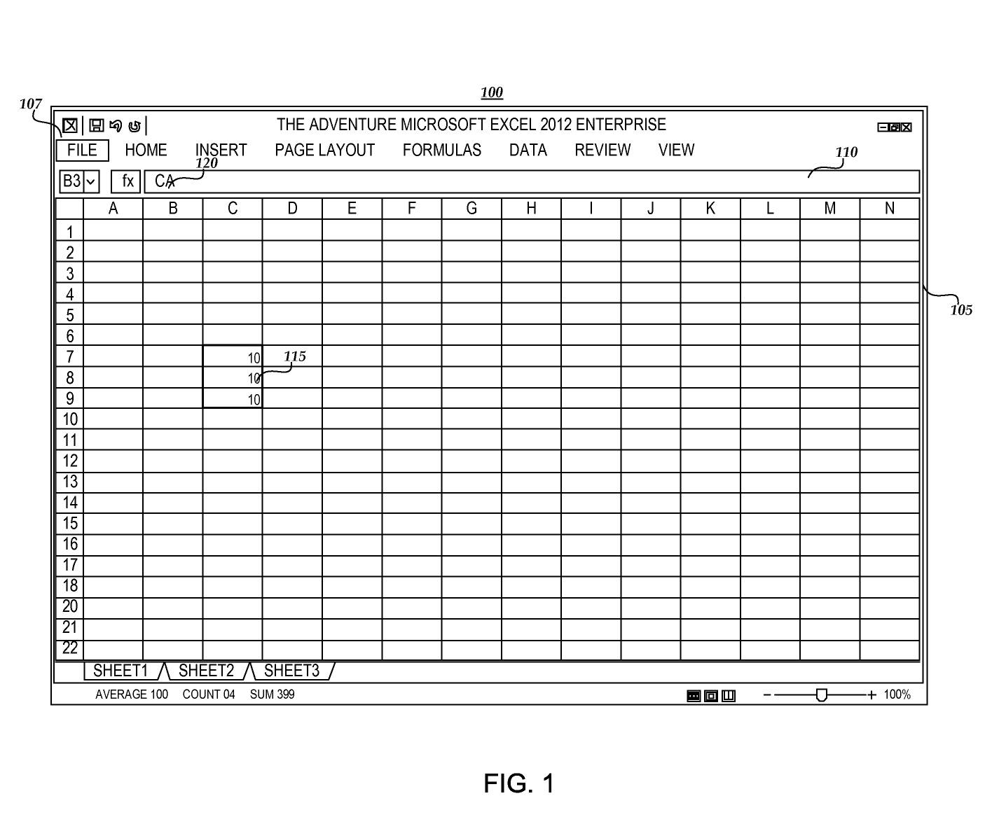

FIG. 1 is a computer screen display of a user interface 100 showing a formula output prior to recalculation, in accordance with an embodiment. The user interface 100 may be generated by a spreadsheet application executing on a computing device. The user interface 100 may include a content surface 105 (i.e., a spreadsheet) for displaying formula output values 115. The user interface 100 may further include a toolbar 107 which may provide a menu for generating a formula bar 110 having formula input values 120 for a formula. The formula output values 115 may comprise values (i.e., the values “10”) in the spreadsheet cells C7-C9 on the content surface 105.

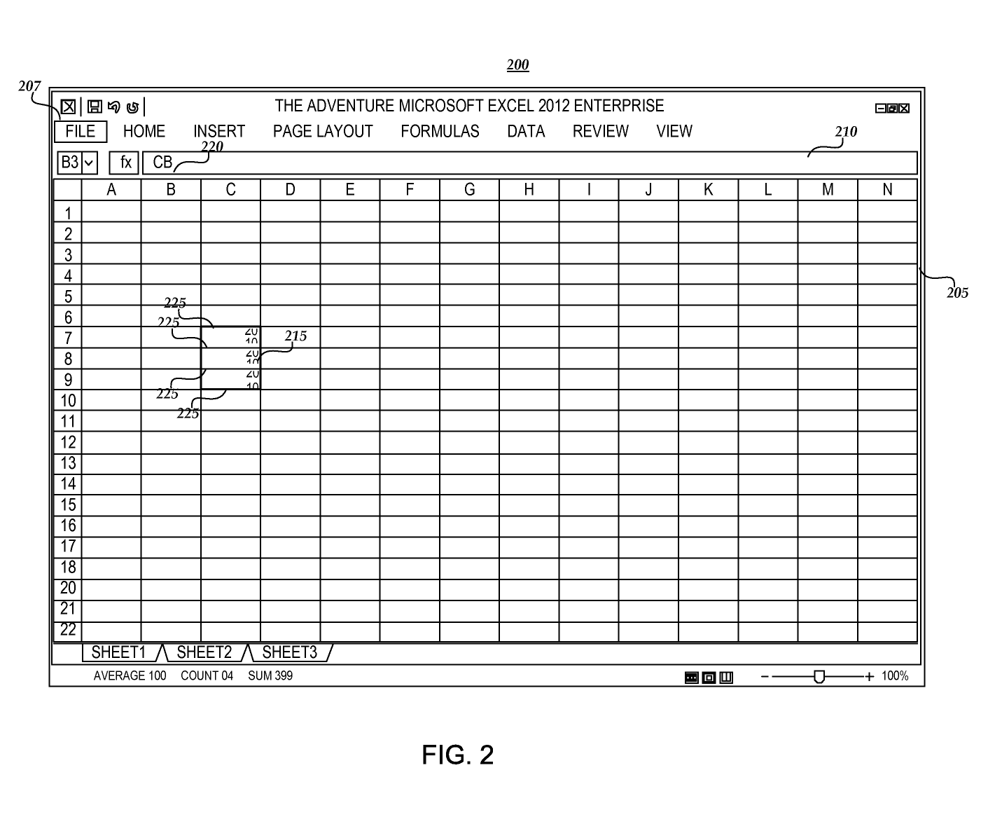

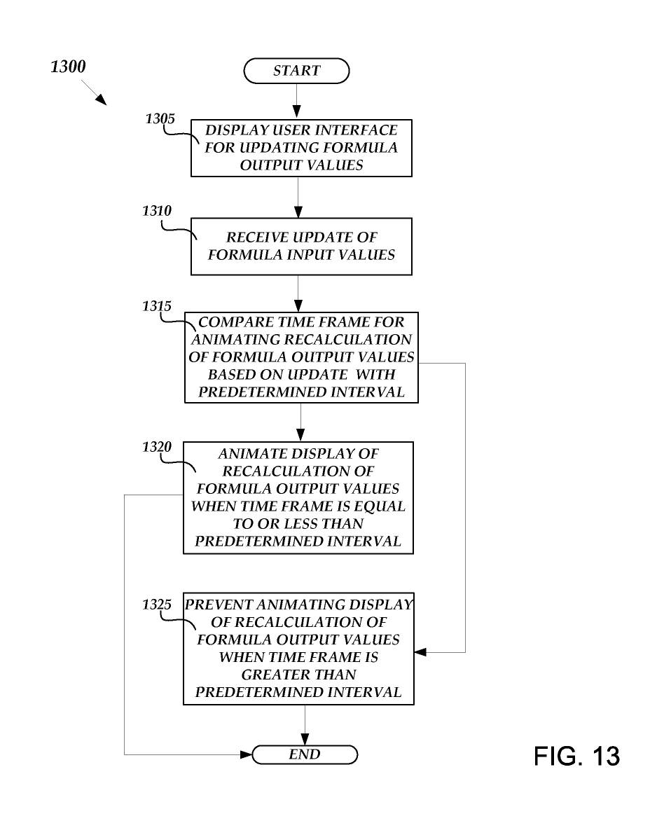

FIG. 2 is a computer screen display of a user interface 200 showing an intermediate stage of an animation of a formula output being recalculated, in accordance with an embodiment. The user interface 200 may be generated by a spreadsheet application executing on a computing device. The user interface 200 may include a content surface 205 (i.e., a spreadsheet) for displaying formula output and recalculated formula output values 215 which are currently being animated. The user interface 200 may further include a toolbar 207 which may provide a menu for generating a formula bar 210 having updated formula input values 220 for a formula. The formula output and recalculated formula output values 215 may comprise the partially shown values “10” (corresponding to formula output values) and the partially shown values “20” (corresponding to recalculated formula output values) in the spreadsheet cells C7-C9 on the content surface 205. The user interface 200 may further include masks 325 at the top and bottom of each row comprising the formula output and recalculated formula output values 215 (i.e., rows 7-9 on the content surface 205). As will be described in greater detail herein, the masks 225 (which may not be visible to a user) may be generated by the spreadsheet application and may function to prevent the formula output and recalculated formula output values 215 from appearing as if they are shifting into a different row of cells on the content surface 205. In accordance with an embodiment and as will be described in greater detail herein with respect to FIG. 13, the formula output values and recalculated formula output values 215 may be animated in response to the receipt of updated formula input values 220 in the formula bar 210. In accordance with an embodiment, a spreadsheet application used for generating the user interface 200 may be configured to show the formula output values slotting out of view on the content surface 205 and the recalculated formula output values :slotting in” to view on the content surface 205 such as may be seen when viewing a slot machine.

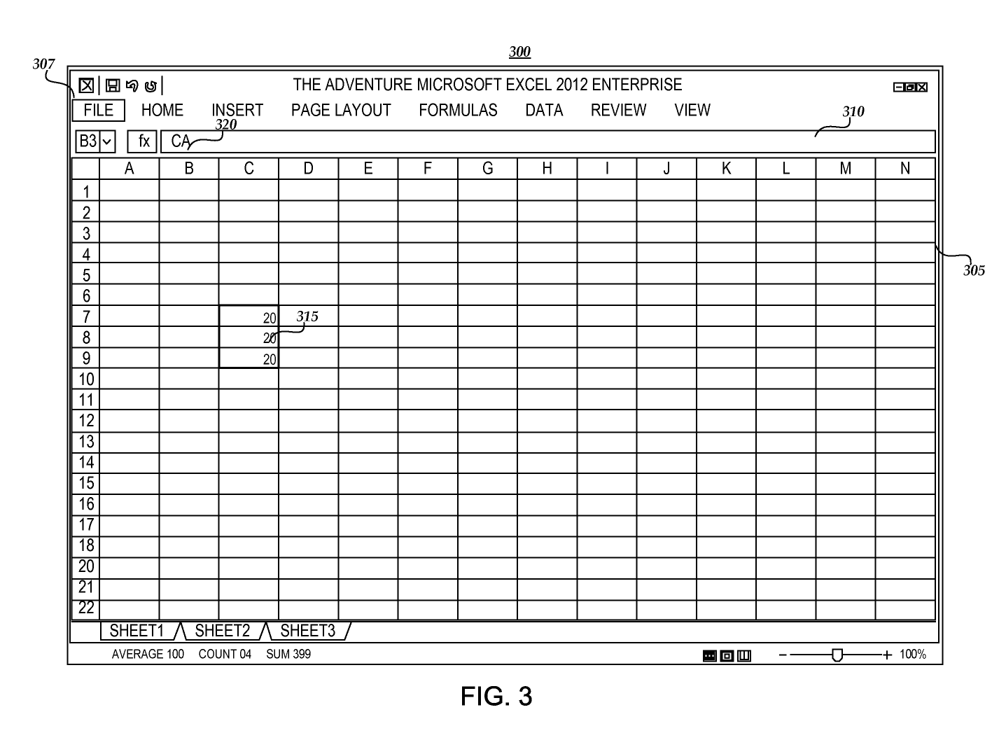

FIG. 3 is a computer screen display of a user interface 300 showing a final stage of an animation of a formula output values being recalculated, in accordance with an embodiment. The user interface 300 may be generated by a spreadsheet application executing on a computing device. The user interface 300 may include a content surface 305 (i.e., a spreadsheet) for displaying recalculated formula output values 315. The user interface 300 may further include a toolbar 307 which may provide a menu for generating a formula bar 310 having updated formula input values 320 for a formula. The recalculated formula output values 315 may comprise values (i.e., the values “20”) in the spreadsheet cells C7-C9 which are displayed on the content surface 305 following the completion of the animation described above with respect to FIGS. 1-2.

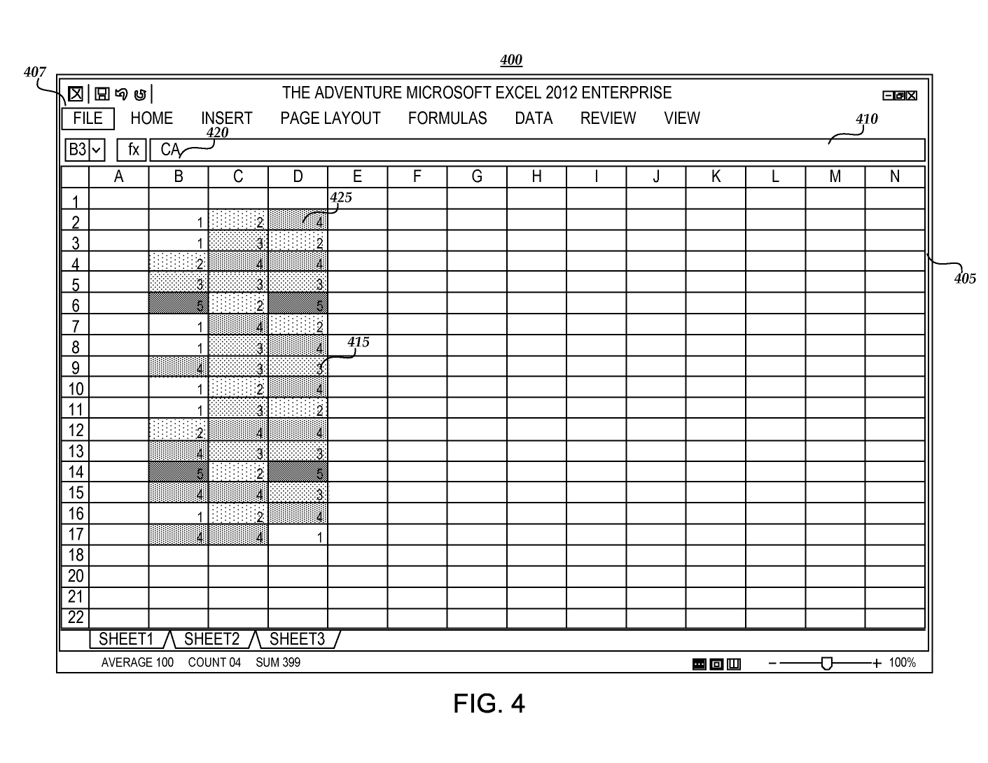

FIG. 4 is a computer screen display of a user interface 400 showing formula output values prior to recalculation, in accordance with an embodiment. The user interface 400 may be generated by a spreadsheet application executing on a computing device. The user interface 400 may include a content surface 405 (i.e., a spreadsheet) for displaying formula output values 415. The user interface 400 may further include a toolbar 407 which may provide a menu for generating a formula bar 410 having formula input values 420 for a formula. The formula output values 415 may comprise values (i.e., the values 1-5) in the spreadsheet cells B2-B17, C2-C17 and D2-D17 on the content surface 405. The user interface 400 may further include cell backgrounds, such as the cell background 425, for each of the spreadsheet cells comprising the formula output values 415. In accordance with various embodiments, the cell backgrounds in the user interface 400 may comprise different types of formatting (such as different colors or shading) associated with each of the formula output values 415. For example, in the user interface 400, the cells comprising the formula output value “1” may be have a yellow cell background while the cells comprising the formula output value “5” may have a red background. As another example, the cells comprising the formula output “2” may have a lightly shaded background while the cells comprising the formula output “4” may have a medium shaded background. In accordance with an embodiment, the formatting of the cell backgrounds may comprise conditional formatting which may change in accordance with changes to the formula output values 415. For example, if after a recalculation, the value of cell B2 on the content surface 405 changes from “1” to “5”, the cell background for B2 may also change in color from yellow to red.

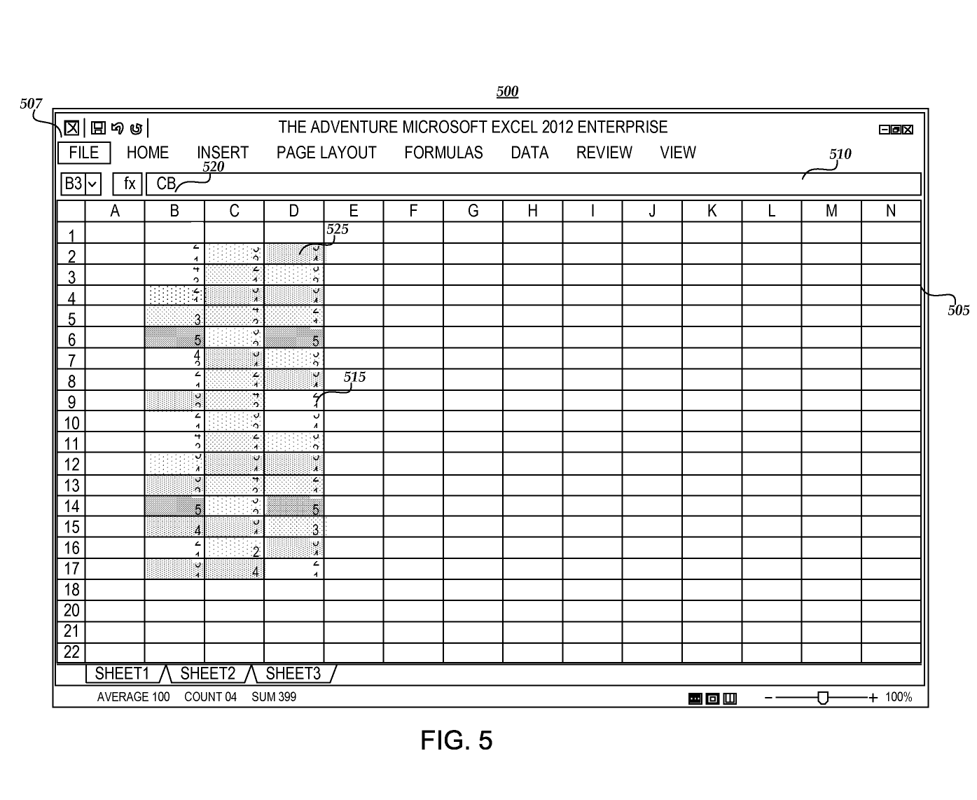

FIG. 5 is a computer screen display of a user interface 500 showing an intermediate stage of an animation of formula output values being recalculated, in accordance with an embodiment. The user interface 500 may be generated by a spreadsheet application executing on a computing device. The user interface 500 may include a content surface 505 (i.e., a spreadsheet) for displaying a partial view of formula output values 515 and a partial view of recalculated formula output values (shown below the formula output values 515 in various cells in the spreadsheet). In particular, the user interface 500 shows the formula output values 515 being animated and in the process of transitioning to the recalculated formula output values. The user interface 500 may further include a toolbar 507 which may provide a menu for generating a formula bar 510 having updated formula input values 520 for a formula. The user interface 500 may further include masks (not shown) at the top and bottom of each row comprising the formula output values 515. The masks may be generated by the spreadsheet application to prevent the recalculated formula output values from appearing as if they are shifting into a different row of cells on the content surface 505. In accordance with an embodiment and as will be described in greater detail herein with respect to FIG. 13, the formula output values 515 may be animated in response to the receipt of the updated formula input values 520 in the formula bar 510. In accordance with an embodiment, a spreadsheet application used for generating the user interface 500 may be configured to show the formula output values 515 “slotting out” and the recalculated formula output values “slotting in” on the content surface 505 such as may be seen when viewing a slot machine. The user interface 500 may further include cell backgrounds, such as the cell background 525, for each of the spreadsheet cells comprising the formula output values 525. In accordance with an embodiment, the cell backgrounds may contain conditional formatting and crossfade as the formula output values 515 change to recalculated values. For example, as the formula output value in cell C2 “slots” from the value “2” to the recalculated formula output value “3”, the background of cell C2 may simultaneously crossfade from a previously formatted dark green color to a lighter green color. It should be appreciated that having different types of animation (i.e., “slotting” and “crossfading”) for the recalculation and the conditional formatting of a cell may result in a more visually pleasing and intuitive experience for the user.

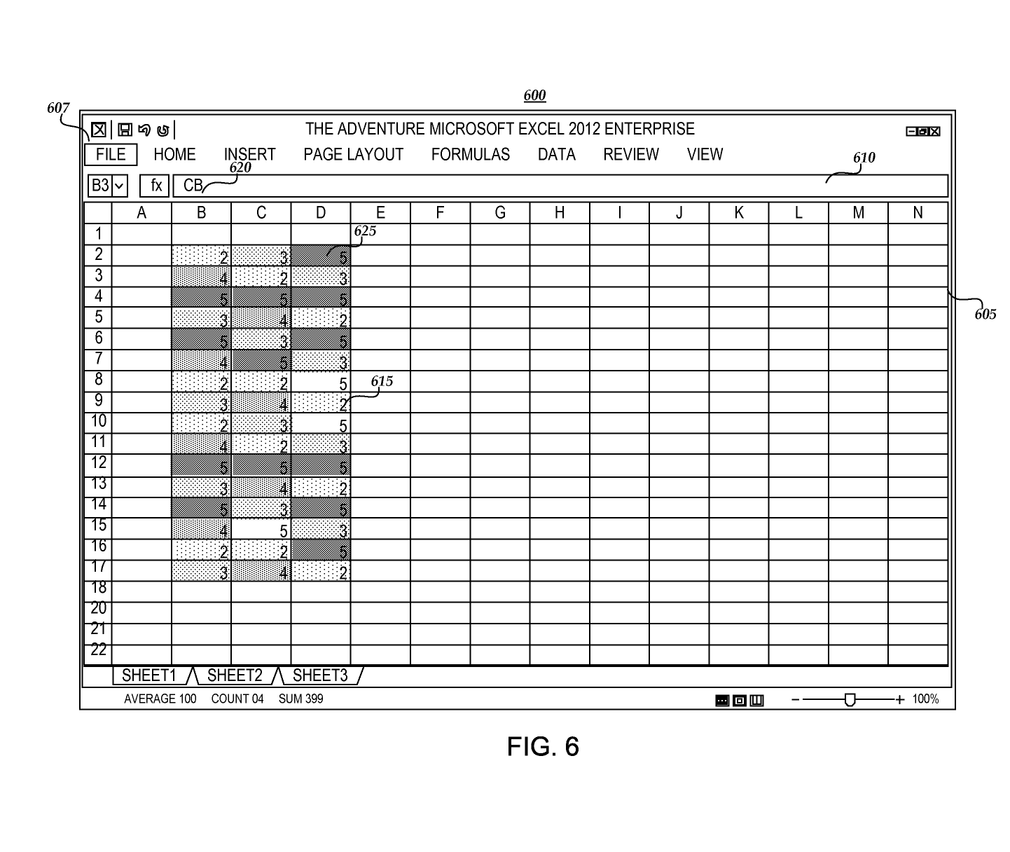

FIG. 6 is a computer screen display of a user interface 600 showing a final stage of an animation of a formula output values being recalculated, in accordance with an embodiment. The user interface 600 may be generated by a spreadsheet application executing on a computing device. The user interface 600 may include a content surface 605 (i.e., a spreadsheet) for displaying recalculated formula output values 615. The user interface 600 may further include a toolbar 607 which may provide a menu for generating a formula bar 610 having updated formula input values 620 for a formula. The recalculated formula output values 615 may comprise values (i.e., the values 1-5) in the spreadsheet cells B2-B17, C2-C17 and D2-D17 on the content surface 605. The user interface 600 may further include cell backgrounds, such as the cell background 625, for each of the spreadsheet cells comprising the formula output values 615. In accordance with an embodiment, the cell backgrounds may contain updated formatting based on the recalculated formula output values 615. For example, cells displaying new (i.e., recalculated) formula output values may (as a result of crossfading) have darker or lighter backgrounds or darker or lighter shading than old formula output values previously displayed in the same cells. It should be understood that the formula output values and the recalculated formula output values in FIGS. 4-6 animate independently from their cell backgrounds. In particular, and as discussed above, it should be understood that in accordance with an embodiment, the recalculation animation for formula output values “slot” while the cell backgrounds crossfade.

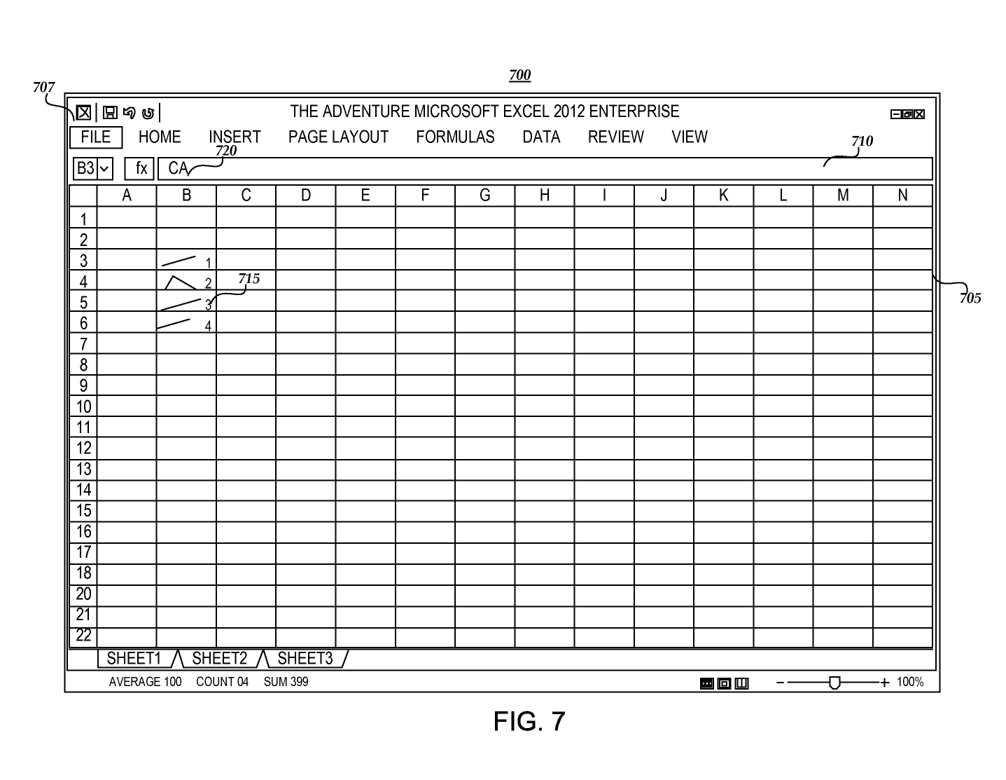

FIG. 7 is a computer screen display of a user interface 700 showing “sparklines” prior to being updated, in accordance with an embodiment. The user interface 700 may be generated by a spreadsheet application executing on a computing device. The user interface 700 may include a content surface 705 (i.e., a spreadsheet) for displaying sparklines 715 in cells B3-B6 in a spreadsheet. Each of the sparklines 715 in the cells B3-B6 may be displayed with an associated data value (i.e., the values 1-4). As should be understood by those skilled in the art, sparklines may comprise small information graphics or charts which may be displayed in a spreadsheet cell to provide a visual representation of data. Sparklines may be utilized to show trends in a series of values, such as seasonal increases or decreases, economic cycles, or to highlight maximum and minimum values. In accordance with an embodiment, the sparklines 715 may comprise a visual representation of formula input data 720 in formula bar 710. The user interface 700 may further include a toolbar 707 which may provide a menu for generating the formula bar 710 having the formula input values 720 for a formula.

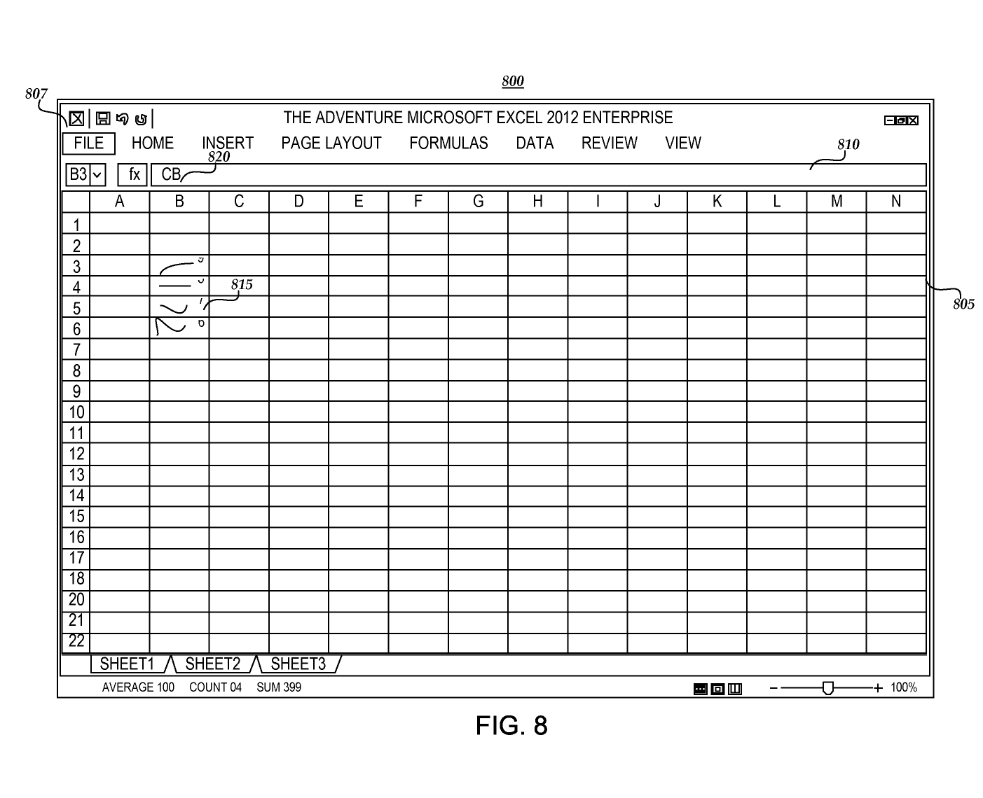

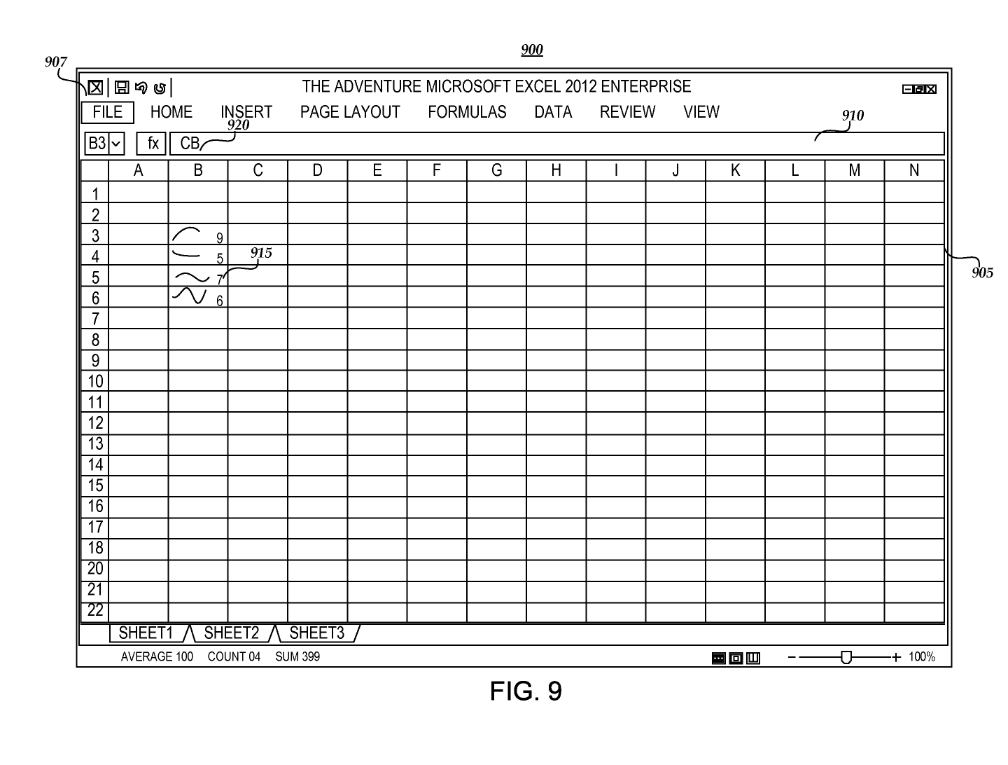

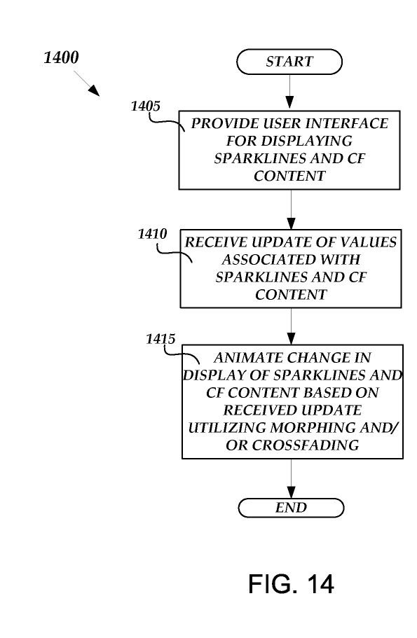

FIG. 8 is a computer screen display of a user interface 800 showing an intermediate stage of an animation of sparklines being updated, in accordance with an embodiment. The user interface 800 may be generated by a spreadsheet application executing on a computing device. The user interface 800 may include a content surface 805 (i.e., a spreadsheet) for displaying sparklines 815 which are in the process of being animated in cells B3-B6 in a spreadsheet. In accordance with an embodiment and as will be described in greater detail herein with respect to FIG. 14, the sparklines 815 may be animated in response to the receipt of updated formula input values 820 in formula bar 810. It should be understood that the animation of the sparklines 815 may comprise a morphing or crossfading animation. For example, in accordance with an embodiment, the sparklines 815 may “morph” from an old position (as shown in FIG. 7) to a new position (as shown in FIG. 9, described below). As another example (and in accordance with an alternative embodiment), the sparklines 815 may crossfade between old and new positions in their respective cells. It should be understood that the sparklines 815 shown in FIG. 8 may comprise an intermediate position between the old and new positions during a morphing or a crossfading animation. It should further be understood, that in accordance with an embodiment, the data values associated with the sparklines 815 may also animate independently (and simultaneously) via a “slotting” animation. The user interface 800 may further include a toolbar 807 which may provide a menu for generating the formula bar 810 having the updated formula input values 820 for a formula.

FIG. 9 is a computer screen display of a user interface 900 showing a final stage of an animation of sparklines being updated, in accordance with an embodiment. The user interface 900 may be generated by a spreadsheet application executing on a computing device. The user interface 900 may include a content surface 905 (i.e., a spreadsheet) for displaying sparklines 915 after having been animated in cells B3-B6 in a spreadsheet. The user interface 900 may further comprise updated formula input data 920 in formula bar 910. The user interface 900 may further include a toolbar 907 which may provide a menu for generating the formula bar 910 having the updated formula input values 920 for a formula.

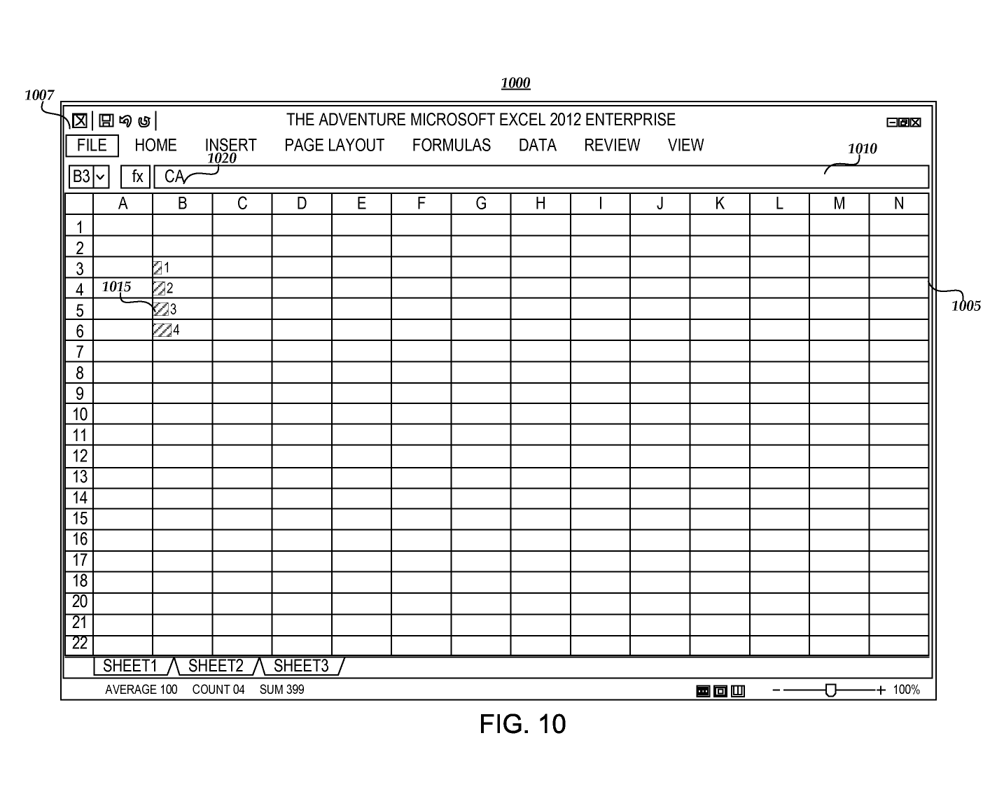

FIG. 10 is a computer screen display of a user interface 1000 showing conditional formatting data bars prior to being updated, in accordance with an embodiment. The user interface 1000 may be generated by a spreadsheet application executing on a computing device. The user interface 1000 may include a content surface 1005 (i.e., a spreadsheet) for displaying conditional formatting (“CF”) data bars 1015 in cells B3-B6 in a spreadsheet. Each of the CF data bars 1015 may comprise a visual representation of formula input data 1020 in formula bar 1010. The user interface 1000 may further include a toolbar 1007 which may provide a menu for generating the formula bar 1010 having the formula input values 1020 for a formula.

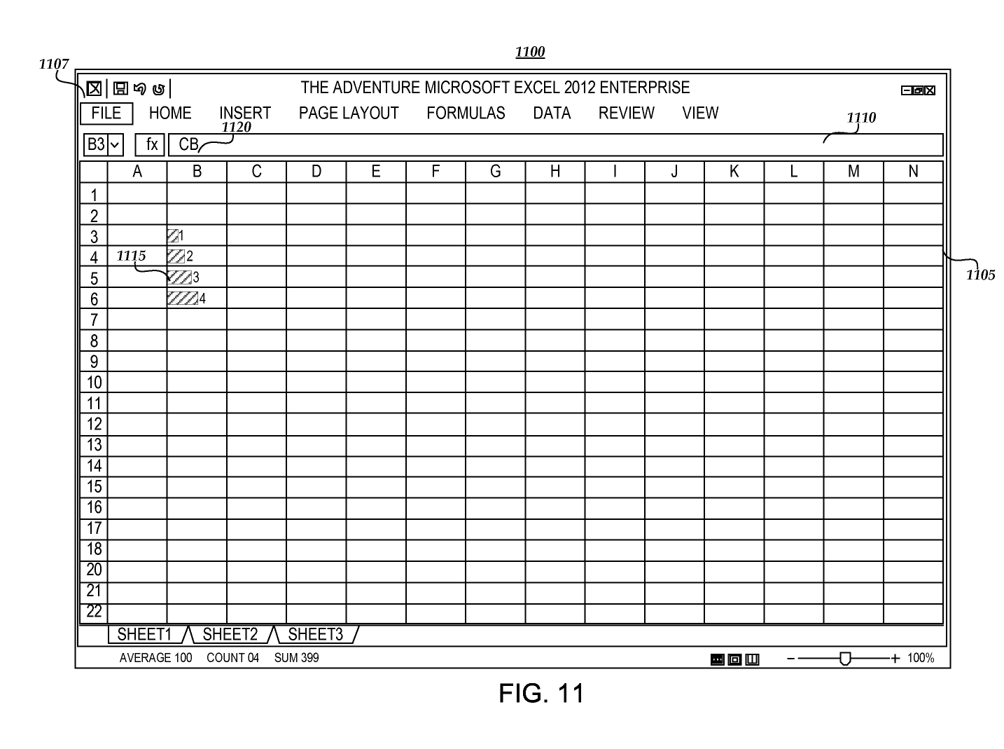

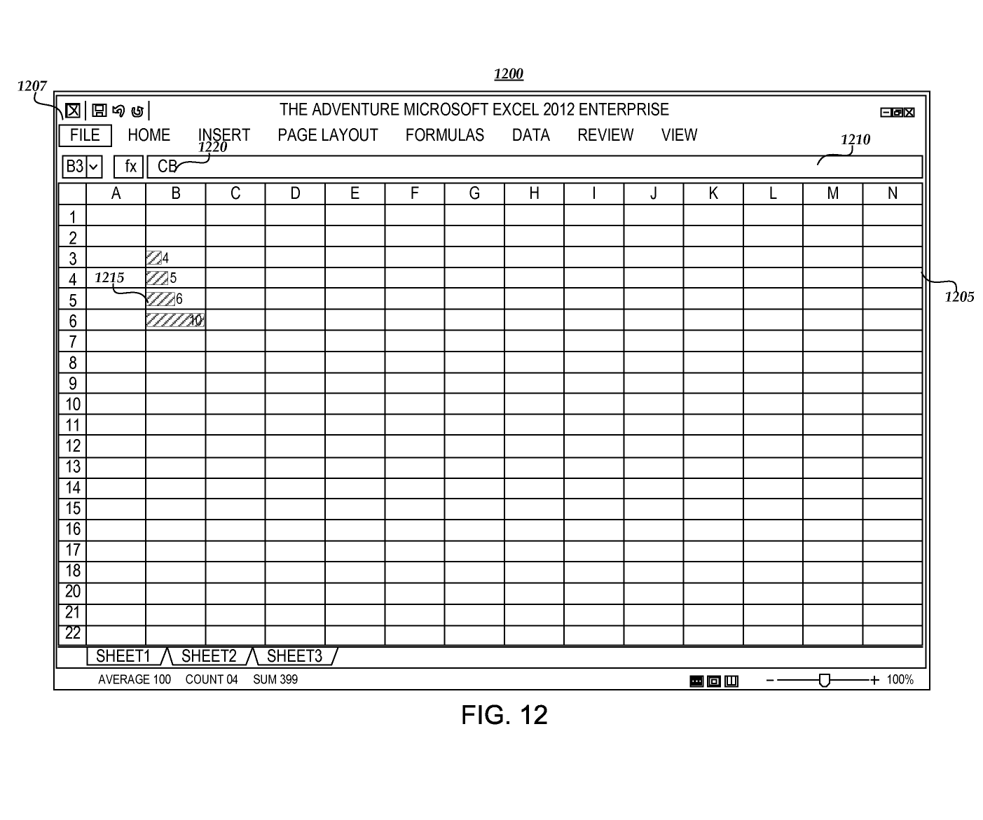

FIG. 11 is a computer screen display of a user interface 1100 showing an intermediate stage of an animation of conditional formatting data bars being updated, in accordance with an embodiment. The user interface 1100 may be generated by a spreadsheet application executing on a computing device. The user interface 1100 may include a content surface 1105 (i.e., a spreadsheet) for displaying CF data bars 1115 which are in the process of being animated in cells B3-B6 in a spreadsheet. In accordance with an embodiment and as will be described in greater detail herein with respect to FIG. 14, the CF data bars 1115 may be animated in response to the receipt of updated formula input values 1120 in formula bar 1110. It should be understood that the animation of the CF data bars 1115 may comprise a morphing or crossfading animation. For example, in accordance with an embodiment, the CF data bars 1115 may “morph” from an old position (as shown in FIG. 10) to a new position (as shown in FIG. 12, described below). As another example (and in accordance with an alternative embodiment), the CF data bars 1115 may crossfade between old and new positions in their respective cells. It should be understood that the CF data bars 1115 shown in FIG. 11 may comprise an intermediate position between the old and new positions during a morphing or a crossfading animation. The user interface 1100 may further include a toolbar 1107 which may provide a menu for generating the formula bar 1110 having the updated formula input values 1120 for a formula.

FIG. 12 is a computer screen display of a user interface 1200 showing a final stage of an animation of conditional formatting data bars being updated, in accordance with an embodiment. The user interface 1200 may be generated by a spreadsheet application executing on a computing device. The user interface 1200 may include a content surface 1205 (i.e., a spreadsheet) for displaying CF data bars 1215 after having been animated in cells B3-B6 in a spreadsheet. The user interface 1200 may further comprise updated formula input data 1220 in formula bar 1210. The user interface 1200 may further include a toolbar 1207 which may provide a menu for generating the formula bar 1210 having the updated formula input values 1220 for a formula. It should be understood, that in accordance with an embodiment, data values may be left aligned with the right edge of each of the CF data bars 1215 and may change from original values to final values as a result of the animation of the CF data bars 1215, thereby providing an additional sense of movement when the data values change.

FIG. 13 is a flow diagram illustrating a routine 1300 for animating the recalculation of formulas in a spreadsheet, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 13-14 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 1300 begins at operation 1305, where a computing device may be utilized to execute a spreadsheet application for displaying a user interface for updating formula output values on a content surface (i.e., a spreadsheet).

From operation 1305, the routine 1300 continues to operation 1310, where the spreadsheet application executing on the computing device may receive an update of formula input values in a formula utilized for generating the formula output values on the content surface.

From operation 1310, the routine 1300 continues to operation 1315, where the spreadsheet application executing on the computing device may compare a time frame for animating the display of the formula output values being replaced with recalculated formula output values on the content surface, with a predetermined interval. In particular, the spreadsheet application may be configured to determine whether animating a number of cells containing the formula output values will affect an overall performance of playing the animation to a user. In accordance with one embodiment, the spreadsheet application may be configured with a predetermined interval for which the animation of cells containing the formula output values is considered acceptable. For example, the spreadsheet application may be configured to allow 200 milliseconds (i.e., the predetermined interval) for the completion of any animation effects in a spreadsheet. Upon receiving the updated formula input values, the spreadsheet application may be configured to then determine a time frame for animating the recalculation of the formula output values in a spreadsheet. The spreadsheet application may then be configured to compare the determined time frame with the predetermined interval before initiating the animation. In accordance with a further embodiment, the spreadsheet application may be configured to employ logic in determining whether or not it would be informative/helpful to play an animation of formula output values being replaced with recalculated formula output values. For example, the content surface may contain the formula “=TODAY( )” for outputting today's date. Since the output of the aforementioned formula will not change in value until the following day, the spreadsheet application may determine that it would not be helpful to the user to animate the recalculation of this formula and thus no animation would take place in this instance. It should be understood that the spreadsheet application may be configured to apply the aforementioned logic to other formulas as well in which the output of the formula would not change as a result of the formula being recalculated. It should be understood that in accordance with the aforementioned embodiment, the logic employed by the spreadsheet application may include a determination of whether the formula to be recalculated is a volatile function. As defined herein, volatile formulas in a spreadsheet may include volatile functions, formulas with volatile functions in them, and the dependent cells of volatile formulas. Thus, in accordance with the present embodiment, volatile formulas may only animate (i.e., slot animate) in a spreadsheet when there is a change in a formula output value. For example, the recalculation of the formula “=NOW( )” in a spreadsheet cell would only slot animate when its value changes.

From operation 1315, the routine 1300 continues to operation 1320, where the spreadsheet application executing on the computing device may animate a display of the formula output values being replaced with recalculated formula output values upon determining that the time frame is equal to or less than the predetermined interval. It should be understood that the while the formula output values and the recalculated formula output values are shown as numbers in the example user interface screen displays discussed above with respect to FIGS. 1-6, those skilled in the art should appreciate that other types of data may also be generated as the result of a recalculated formula. For example, the recalculated formula output values shown in the aforementioned figures may also comprise dates and text. In accordance with an embodiment, the animation may comprise displaying a gradual transition in which formula output values are replaced with recalculated formula output values. In accordance with an embodiment, the formula output values may be within cells having conditional formatting applied in the background. In this circumstance, the animation of the formula output values may take place independently of any background conditional formatting. In accordance with an embodiment and as discussed above, the conditional formatting may also be animated in a distinct manner with respect to the formula output values. For example, as discussed above, the animation of the formula output values may comprise a “slot machine” effect while the animation of the conditional formatting may comprise a crossfading effect. In accordance with an embodiment, the spreadsheet application may configured to add a mask above and below a row of cells comprising the formula output values to prevent the recalculated formula output values from appearing to shift into a different row of cells during animation. From operation 1320, the routine 1300 then ends.

Returning now to operation 1315, if it is determined that the time frame for animating the display of the formula output values is greater than the predetermined interval, the routine 1300 branches to operation 1325 where the spreadsheet application executing on the computing device may prevent the animation of the formula output values being replaced with recalculated formula output values. It should be appreciated that preventing the animation of the formula output values under these circumstances prevents animations from playing that would be too slow and further prevents partial animations (i.e., animating half of a group of spreadsheet cells that are recalculating but not the other half), the display of which may be confusing to a user. From operation 1325, the routine 1300 then ends.

FIG. 14 is a flow diagram illustrating a routine 1400 for animating sparklines and conditionally formatted content in a spreadsheet, in accordance with an embodiment. The routine 1400 begins at operation 1405, where a computing device may be utilized to execute a spreadsheet application which provides a user interface for displaying sparklines and conditionally formatted (CF) content in the spreadsheet. In accordance with an embodiment, the sparklines may comprise line graphs, bar graphs and win/loss graphs. In accordance with an embodiment, the CF content may comprise CF data bars. In accordance with another embodiment, the CF content may comprise solid backgrounds, borders and icon sets.

From operation 1405, the routine 1400 continues to operation 1410, where the spreadsheet application executing on the computing device may receive an update of data values associated with sparklines and/or the CF content in the spreadsheet.

From operation 1410, the routine 1400 continues to operation 1415, where the spreadsheet application executing on the computing device may animate changes in the display of the sparklines and the CF content in the spreadsheet based on the received updated data values. In accordance with an embodiment, the animation of the sparklines and certain CF content (i.e., data bars) may comprise a morphing animation from old positions to new positions as discussed above with respect to FIGS. 8-13. In accordance with another embodiment, the animation of the sparklines and CF content (i.e., data bars, solid backgrounds, borders and icon sets) may comprise a crossfading animation from old positions to new positions as discussed above with respect to FIGS. 8-13. From operation 1415, the routine 1400 then ends.

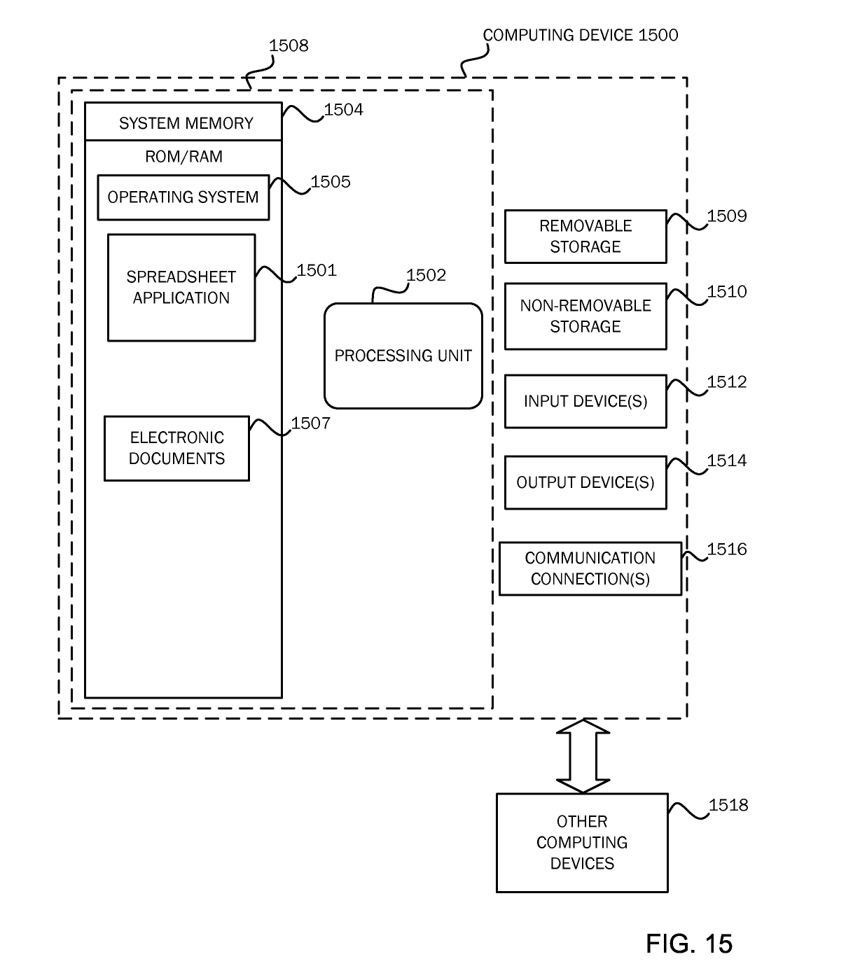

FIG. 15 is a block diagram illustrating example physical components of a computing device 1500 with which various embodiments may be practiced. The computing device components described below may be suitable for the computing device described above with respect to FIGS. 1-14. In a basic configuration, the computing device 1500 may include at least one processing unit 1502 and a system memory 1504. Depending on the configuration and type of computing device, system memory 1504 may comprise, but is not limited to, volatile (e.g. random access memory (RAM)), non-volatile (e.g. read-only memory (ROM)), flash memory, or any combination. System memory 1504 may include an operating system 1505, spreadsheet application 1501 and electronic documents (i.e., spreadsheet documents) 1507. Operating system 1505, for example, may be suitable for controlling computing device 1500′s operation and, in accordance with an embodiment, may comprise the WINDOWS operating systems from MICROSOFT CORPORATION of Redmond, Wash. The spreadsheet application 1501 may comprise the EXCEL spreadsheet software from MICROSOFT CORPORATION of Redmond Wash. It should be understood, however, that other spreadsheet applications from other manufacturers may be utilized in accordance with the various embodiments described herein. In accordance with an embodiment, the electronic documents 1507 may comprise spreadsheet documents generated by or displayed in a user interface generated by the spreadsheet application 1501. It should be understood that the embodiments described herein may also be practiced in conjunction with other operating systems and application programs and further, is not limited to any particular application or system.

The computing device 1500 may have additional features or functionality. For example, the computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510.

While executing on the processing unit 1502 of the computing device 1500, the spreadsheet applications 1501 may perform routines for animating the recalculation of formulas in a spreadsheet and animating sparklines and conditionally formatted content in a spreadsheet including, for example, one or more of the operations in routines 1300 and 1400 described above. The aforementioned routines are examples, and the processing unit 1502 may perform other routines. Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 15 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the spreadsheet application 1501 may operate via application-specific logic integrated with other components of the computing device/system 1500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Various embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 1500. Any such computer storage media may be part of the computing device 1500. The computing device 1500 may also have input device(s) 1512 such as a keyboard, a mouse, a pen, a sound input device, a touch input device, etc. Output device(s) 1514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

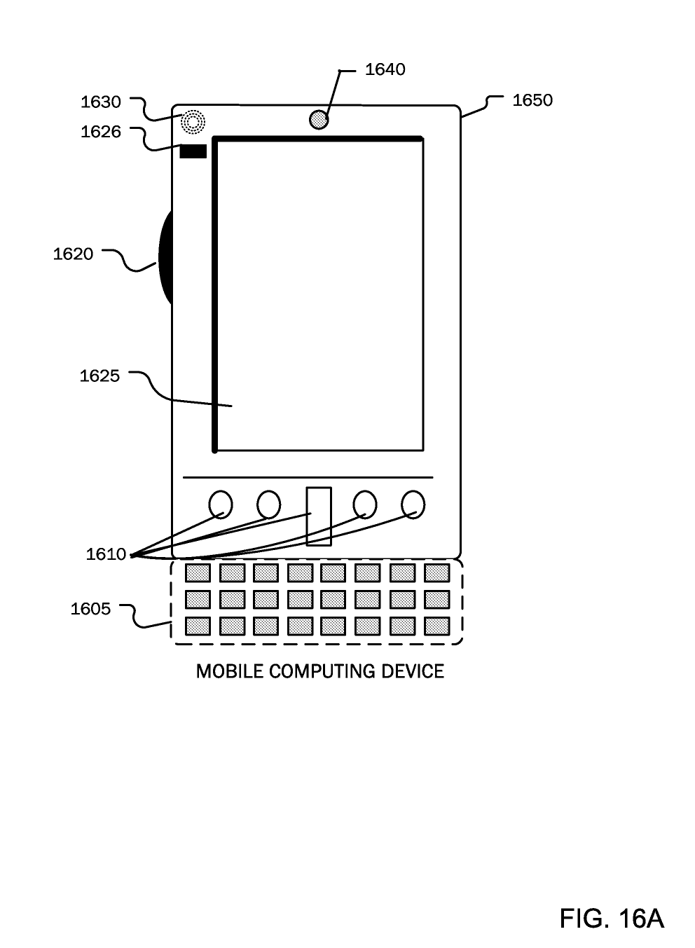

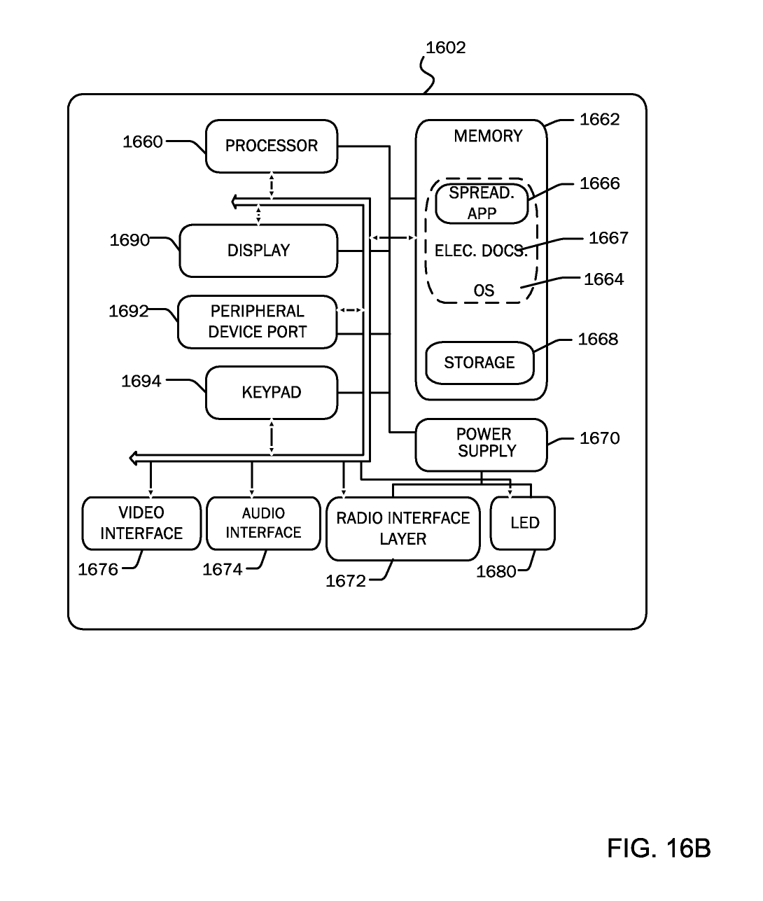

FIGS. 16A and 16B illustrate a suitable mobile computing environment, for example, a mobile telephone 1650, a smartphone, a tablet personal computer, a laptop computer, and the like, with which various embodiments may be practiced. With reference to FIG. 16A, an example mobile computing device 1650 for implementing the embodiments is illustrated. In a basic configuration, mobile computing device 1650 is a handheld computer having both input elements and output elements. Input elements may include touch screen display 1625 and input buttons 1610 that allow the user to enter information into mobile computing device 1650. Mobile computing device 1650 may also incorporate an optional side input element 1620 allowing further user input. Optional side input element 1620 may be a rotary switch, a button, or any other type of manual input element. In alternative embodiments, mobile computing device 1650 may incorporate more or less input elements. For example, display 1625 may not be a touch screen in some embodiments. In yet another alternative embodiment, the mobile computing device is a portable phone system, such as a cellular phone having display 1625 and input buttons 1610. Mobile computing device 1650 may also include an optional keypad 1605. Optional keypad 1605 may be a physical keypad or a “soft” keypad generated on the touch screen display.

Mobile computing device 1650 incorporates output elements, such as display 1625, which can display a graphical user interface (GUI). Other output elements include speaker 1630 and LED light 1626. Additionally, mobile computing device 1650 may incorporate a vibration module (not shown), which causes mobile computing device 1650 to vibrate to notify the user of an event. In yet another embodiment, mobile computing device 1650 may incorporate a headphone jack (not shown) for providing another means of providing output signals.

Although described herein in combination with mobile computing device 1650, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 16B is a block diagram illustrating components of a mobile computing device used in one embodiment, such as the computing device shown in FIG. 16A. That is, mobile computing device 1650 can incorporate a system 1602 to implement some embodiments. For example, system 1602 can be used in implementing a “smart phone” that can run one or more applications similar to those of a desktop or notebook computer such as, for example, the spreadsheet application discussed above with respect to FIGS. 1-14 as well as other applications. In some embodiments, the system 1602 is integrated as a computing device, such as an integrated personal digital assistant (PDA) and wireless phone.

A spreadsheet application 1666 may be loaded into memory 1662 and run on or in association with an operating system 1664. The spreadsheet application 1666 may be perform routines for animating the recalculation of formulas in a spreadsheet and animating sparklines and conditionally formatted content in a spreadsheet including, for example, one or more of the operations in routines 1300 and 1400 described above. The memory 1662 may also include one or more electronic documents 1667 which may be generated by the spreadsheet application 1666. The system 1602 also includes non-volatile storage 1668 within memory the 1662. Non-volatile storage 1668 may be used to store persistent information that should not be lost if system 1602 is powered down. The spreadsheet application 1666 may use and store information in the non-volatile storage 1668. A synchronization application (not shown) also resides on system 1602 and is programmed to interact with a corresponding synchronization application resident on a host computer to keep the information stored in the non-volatile storage 1668 synchronized with corresponding information stored at the host computer. As should be appreciated, other applications may also be loaded into the memory 1662 and run on the device 1650.

The system 1602 has a power supply 1670, which may be implemented as one or more batteries. The power supply 1670 might further include an external power source, such as an AC adapter or a powered docking cradle that supplements or recharges the batteries.

The system 1602 may also include a radio 1672 that performs the function of transmitting and receiving radio frequency communications. The radio 1672 facilitates wireless connectivity between the system 1602 and the “outside world,” via a communications carrier or service provider. Transmissions to and from the radio 1672 are conducted under control of OS 1664. In other words, communications received by the radio 1672 may be disseminated to the spreadsheet application 1666 via OS 1664, and vice versa.

The radio 1672 allows the system 1602 to communicate with other computing devices, such as over a network. The radio 1672 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The embodiment of the system 1602 is shown with two types of notification output devices; an LED 1680 that can be used to provide visual notifications and an audio interface 1674 that can be used with speaker 1630 to provide audio notifications. These devices may be directly coupled to the power supply 1670 so that when activated, they remain on for a duration dictated by the notification mechanism even though processor 1660 and other components might shut down for conserving battery power. The LED 1680 may be programmed to remain on indefinitely until the user takes action to indicate the powered-on status of the device. The audio interface 1674 is used to provide audible signals to and receive audible signals from the user. For example, in addition to being coupled to speaker 1630, the audio interface 1674 may also be coupled to a microphone (not shown) to receive audible input, such as to facilitate a telephone conversation. In accordance with embodiments of the present invention, the microphone may also serve as an audio sensor to facilitate control of notifications. The system 1602 may further include a video interface 1676 that enables an operation of on-board camera 1630 to record still images, video stream, and the like.

A mobile computing device implementing the system 1602 may have additional features or functionality. For example, the device may also include additional data storage devices (removable and/or non-removable) such as, magnetic disks, optical disks, or tape. Such additional storage is illustrated in FIG. 16B by storage 1668. Computer storage media may include volatile and nonvolatile, removable and non-removable media implemented in any method or technology for storage of information, such as computer readable instructions, data structures, program modules, or other data.

Data/information generated or captured by the device 1650 and stored via the system 1602 may be stored locally on the device 1650, as described above, or the data may be stored on any number of storage media that may be accessed by the device via the radio 1672 or via a wired connection between the device 1650 and a separate computing device associated with the device 1650, for example, a server computer in a distributed computing network such as the Internet. As should be appreciated such data/information may be accessed via the device 1650 via the radio 1672 or via a distributed computing network. Similarly, such data/information may be readily transferred between computing devices for storage and use according to well-known data/information transfer and storage means, including electronic mail and collaborative data/information sharing systems.

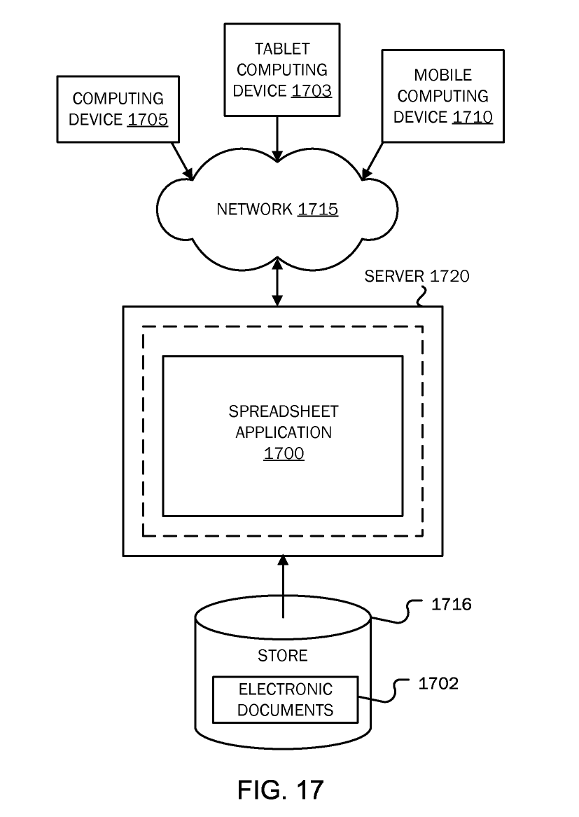

FIG. 17 is a simplified block diagram of a distributed computing system in which various embodiments may be practiced. The distributed computing system may include number of client devices such as a computing device 1705, a tablet computing device 1703 and a mobile computing device 1710. The client devices 1705, 1703 and 1710 may be in communication with a distributed computing network 1715 (e.g., the Internet). A server 1720 is in communication with the client devices 1705, 1703 and 1710 over the network 1715. The server 1720 may store spreadsheet application 1700 which may be perform routines for animating the recalculation of formulas in a spreadsheet and animating sparklines and conditionally formatted content in a spreadsheet including, for example, one or more of the operations in routines 1300 and 1400 described above. The spreadsheet application 1700 on the server 1720 may be utilized by the client devices 1705, 1703 and 1710 (over the network 1715) to generate electronic documents 1702 and for storing same in a store 1716.

Various embodiments are described above with reference to block diagrams and/or operational illustrations of methods, systems, and computer program products according to embodiments of the invention. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the invention.

It will be apparent to those skilled in the art that various modifications or variations may be made without departing from the scope or spirit of the invention. Other embodiments will be apparent to those skilled in the art from consideration of the specification and practice of the invention disclosed herein.

What is claimed is:

1. A computer-implemented method for animating the recalculation of formulas, comprising:
displaying, by a computer, a user interface for updating at least one formula output value on a content surface;
receiving, by the computer, an update of at least one formula input value in a formula utilized for generating the at least one formula output value on the content surface; and
animating, by the computer, a display of the at least one formula output value being replaced with at least one recalculated formula output value on the content surface based on the update of the at least one formula input value.

2. The method of claim 1, wherein animating, by the computer, a display of the at least one formula output value being replaced with at least one recalculated formula output value on the content surface based on the update of the at least one formula input value comprises displaying a gradual transition in which the at least one formula output value is replaced with at the least one recalculated formula output value on the content surface.

3. The method of claim 1, wherein animating, by the computer, a display of the at least one formula output value being replaced with at least one recalculated formula output value on the content surface based on the update of the at least one formula input value comprises animating a display of a plurality of formula output values being replaced with a plurality of recalculated formula output values on the content surface.

4. The method of claim 3, further comprising:
comparing a time frame for animating the display of the plurality of formula output values being replaced with the plurality of recalculated formula output values on the content surface with a predetermined interval; and
animating the display of the plurality of formula output values being replaced with the plurality of recalculated formula output values on the content surface upon determining that the time frame is equal to or less than the predetermined interval.

5. The method of claim 4, further comprising preventing the animating of the display of the plurality of formula output values being replaced with the plurality of recalculated formula output values on the content surface upon determining that the time frame is greater than the predetermined interval.

6. The method of claim 1, wherein animating, by the computer, a display of the at least one formula output value being replaced with at least one recalculated formula output value on the content surface based on the update of the at least one formula input value comprises animating the display of the at least one formula output value being replaced with the at least one recalculated formula output value independently of conditional formatting applied to a background of at least one cell on the content surface, wherein the at least one cell comprises the at least one formula output value and the content surface comprises a spreadsheet.

7. The method of claim 6, further comprising animating the conditional formatting applied to the background of the at least one cell on the spreadsheet upon the at least one formula output value being replaced with the at least one recalculated formula output value on the spreadsheet, wherein animating the conditional formatting comprises an animation which is distinct from an animation associated with the replacement of the at least formula output value with the at least one recalculated formula output value.

8. The method of claim 1, wherein animating a display of a plurality of formula output values being replaced with a plurality of recalculated formula output values on the content surface comprises adding a mask above and below a row of cells comprising the plurality of formula output values to prevent the plurality of recalculated formula output values from appearing to shift into a different row of cells located above or below the row of cells comprising the plurality of formula output values.

9. A computer system for animating the recalculation of formulas in a spreadsheet, comprising:
a memory for storing executable program code; and
a processor, functionally coupled to the memory, the processor being responsive to computer-executable instructions contained in the program code and operative to:
display a user interface for updating a plurality of formula output values on the spreadsheet;
receive an update of at least one formula input value in a formula utilized for generating the plurality of formula output values on the spreadsheet; and
animate a display of the plurality of formula output values being replaced with a plurality of recalculated formula output values on the spreadsheet based on the update of the at least one formula input value.

10. The system of claim 9, wherein the processor is further operative to:
compare a time frame for animating the display of the plurality of formula output values being replaced with the plurality of recalculated formula output values on the spreadsheet with a predetermined interval; and
animate the display of the plurality of formula output values being replaced with the plurality of recalculated formula output values on the spreadsheet upon determining that the time frame is equal to or less than the predetermined interval.

11. The system of claim 10, wherein the processor is further operative to:
prevent the animation of the display of the plurality of formula output values being replaced with the plurality of recalculated formula output values on the spreadsheet upon determining that the time frame is greater than the predetermined interval.

12. The system of claim 9, wherein the processor, in animating a display of the plurality of formula output values being replaced with a plurality of recalculated formula output values on the spreadsheet based on the update of the at least one formula input value, is further operative to animate the display of the plurality of formula output values being replaced with the plurality of recalculated formula output values independently of conditional formatting applied to a background of each of a plurality of cells on the spreadsheet.

13. The system of claim 12, wherein the plurality of cells comprises the plurality of formula output values.

14. The system of claim 12, wherein the processor is further operative to animate the conditional formatting applied to the background of each of the plurality of cells on the spreadsheet upon the plurality of formula output values being replaced with the plurality of recalculated formula output values on the spreadsheet, wherein the animation of the conditional formatting is distinct from an animation associated with the replacement of the plurality of formula output values with the plurality of recalculated formula output values.

15. The system of claim 9, wherein the processor, in animating a display of the plurality of formula output values being replaced with a plurality of recalculated formula output values on the spreadsheet based on the update of the at least one formula input value, is further operative to add a mask above and below a row of cells comprising the plurality of formula output values to prevent the plurality of recalculated formula output values from appearing to shift into a different row of cells located above or below the row of cells comprising the plurality of formula output values.

16. The system of claim 9, wherein the processor, in animating a display of the plurality of formula output values being replaced with a plurality of recalculated formula output values on the spreadsheet based on the update of the at least one formula input value, is further operative to display a gradual transition in which the plurality of formula output values are replaced with the plurality of recalculated formula output values on the spreadsheet.

17. A computer-readable storage medium comprising computer executable instructions which, when executed by a computer, will cause the computer to perform a method for animating sparklines and conditionally formatted content in a spreadsheet, the method comprising:
providing a user interface for displaying at least one of a sparkline and conditionally formatted content in the spreadsheet;
receiving an update of at least one value associated with the at least one of the sparkline and the conditionally formatted content in the spreadsheet; and
animating a change in the display of the at least one of the sparkline and the conditionally formatted content based on the received update.

18. The computer-readable storage medium of claim 17, wherein animating a change in the display of the at least one of the sparkline and the conditionally formatted content based on the received update comprises at least one of morphing and crossfading a display of at least one: a line graph, a bar graph and a win/loss graph from an old position to a new position in the spreadsheet.

19. The computer-readable storage medium of claim 18, wherein animating a change in the display of the at least one of the sparkline and the conditionally formatted content based on the received update further comprises at least one of morphing and crossfading a display of data bars from an old position to a new position in the spreadsheet.

20. The computer-readable storage medium of claim 17, wherein animating a change in the display of the at least one of the sparkline and the conditionally formatted content based on the received update comprises crossfading a display of at least one of solid backgrounds, borders and icon sets in the spreadsheet.
